(19) United States
(12) Patent Application Publication
(10) Pub. No.: US 2012/0229640 A1
(43) Pub. Date: Sep. 13, 2012

(54) Mobile Advertising System

(76) Inventor: Rubio Angel, Miami, FL (US)

(21) Appl. No.: 13/045,050

(22) Filed: Mar. 10, 2011

(51) Int. Cl. H04N 7/18

(52) U.S. Cl. 348/148; 348/E07.085

(57) ABSTRACT

A mobile advertising system is provided that is removably affixable or permanently affixed to the roof of a passenger vehicle. Multiple displays are affixed to a frame so that they can be viewed from positions outside the vehicle. Dynamic video content is inputted to a controller assembly that independently sends a video feed to the displays. Video content is refreshed from internet feeds of from removable memory media. A wide area network connection interfaces the devices with the internet. A local area network connection ‘hot spot’ delivers internet services to passengers of the vehicle. GPS capabilities allow vehicle monitoring and geographically relevant content to be displayed. Other features are present as disclosed in the drawings and written description.

### BACKGROUND OF THE INVENTION

1. Field of the Invention

The present invention relates to advertising, and more particularly, to vehicle mounted advertising equipment and systems.

2. Description of the Related Art

Several designs for mobile advertising systems have been designed in the past. None of them, however, includes a dynamic content roof top color display that is readily portable for affixing to alternate vehicles that also acts as a broadband internet relay for use by occupants of the vehicle that may further include a motion sensor that causes the display to turn on or animate depending on whether the vehicle is moving or being triggered by the speed of the vehicle. Other options and combinations using more or less of the above are also disclosed and claimed.

Applicant believes that the closest reference corresponds to U.S. patent application Ser. No. 12/191,944 filed by Tighe. However, it differs from the present invention because the present invention includes features, in addition to simple advertising, including, inter alia, video security cameras integrated into the unit, an internet ‘hot spot’ to serve web content to passengers and those nearby, has a robust motion activated sensing system and dynamic video content as well as other distinguishing and novel features.

U.S. Pat. No. 6,812,851 issued to Dukach, et. al. also has some relevance to the present invention but it can be easily distinguished from the present disclosure in that a suitable and reliable means to turn the display off or on depending on the mobility status of the vehicle, integrated wireless internet hot spot and other valuable features are provided and disclosed in more detail below.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a safe and reliable mobile advertising system.

It is another object of this invention to provide a device that can be transferred easily from one vehicle to another without damage to the vehicle.

It is still another object of the present invention to provide a device that includes internet connectivity for dynamic advertising content, geographical location information and a reliable internet relay hot spot to enhance a passenger's experience.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of a variation of the invention as it might be affixed atop a passenger vehicle

FIG. 2 shows a perspective view of a version of the device in more detail.

FIG. 3 illustrates a perspective cross section of a variation of the device at cross section indicators shown in FIG. 2.

FIG. 4 is a perspective representation of an alternate variation of the invention.

FIG. 5 is a perspective view of yet another version of the invention.

### DETAILED DESCRIPTION OF THE PREFERRED EMBODIMENT

Referring now to the drawings, where the present invention is generally referred to with numeral 10, it can be observed that, in its primary and alternate variations, basically includes, inter alia, a display 12, a switch 14, a motion detector 16, a frame 18, feet 20, controller assembly 21, processor 22, camera 24, camera 26, antenna 28, antenna 30, antenna 32, power supply 34, panel 36, display 38, feet 40, display 44, cameras 46 and feet 48.

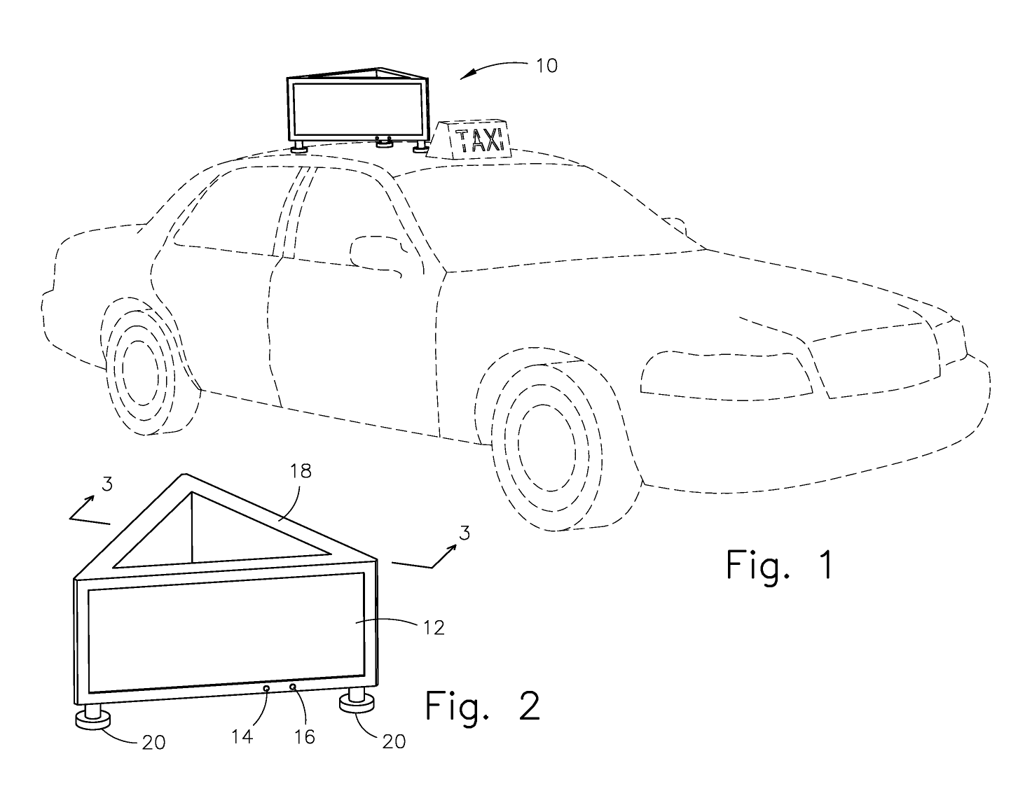

In FIG. 1 the device 10 is shown attached to the roof of a vehicle as it might typically be employed. The device (sometimes also referred to as the invention) is comprised of a frame 18 that supports a plurality of displays 12. In the variation shown in FIGS. 1-3 there are three displays 12 generally connected along the edges to form a triangle that is supported by the frame 18.

The frame 18 has on its bottom edge several feet 20 that are designed to rest on a surface such as the roof of a passenger vehicle. Preferably the feet are resilient and provide some traction on the roof of the vehicle. The feet 20 may be made of rubber, neoprene, silicone, soft plastic or other material capable of supporting the weight of the device while preventing the invention from sliding off the vehicle or damaging the painted surface of the vehicle.

In a prominent variation of the device the feet 20, feet 40 or feet 48 include a magnet or other adhesion means to securely affix the invention to the vehicle yet retaining the ability to un-mount the device from the vehicle for application onto another vehicle. The magnet or other attachment means may also incorporate a non-marring material such as rubber, neoprene, silicone, soft plastic or other durable and resilient material to avoid damage to the vehicle.

For some applications the invention may be permanently affixed to the vehicle by bolts, adhesive or other commonly available means. This may be important for vehicles such as taxis that are often in harsh environments and used continually. This is in contrast to applications, such as pizza delivery vehicles, that are often a driver's personal vehicle so the device is removed after the driver's shift and placed on another vehicle used for deliveries.

If the device is permanently affixed to the vehicle an important variation includes placing the controller assembly 21 in a remote location, such as in the trunk, glove box or under a seat. This can act as a theft deterrent because the device cannot simply be removed from the roof while critical control elements are locked inside the vehicle. This split design, separating the controller assembly 21 from the displays 12, may also permit the dimensions of the car top portions to be reduced and streamlined. For optimal performance the controller assembly 21 and displays 12 are hard wired. However, in some applications is may be preferred to wirelessly connect the displays 12 to the controller assembly 21.

Generally, the displays 12, displays 38 and displays 44 are oriented so that they are viewable from outside the vehicle onto which the device is affixed such as pedestrians or other vehicles. As shown in FIG. 2, a balance is struck between the cost of the displays 12 and the ability of viewers to see the device. In this example, three displays 12 are used that allow viewers to see it from most angles.

In the example shown in FIG. 4 two displays 38 are used facing opposite directions. This decreases the cost of the device, including maintenance and repair, but reduces somewhat the angles at which the displays 38 are viewable. The two display 38 version may also have the advantage of reducing wind resistance when the device is used on a vehicle at higher speeds by allowing the wind to pass through between the displays 38.

In yet another variation as demonstrated in FIG. 5, four displays 44 are employed so that the displays 44 are easily viewable from any angle. It should also be noted that in any of the variations that the different screens 12, 38 or 44 can display the same content or have different signal feed showing alternate content.

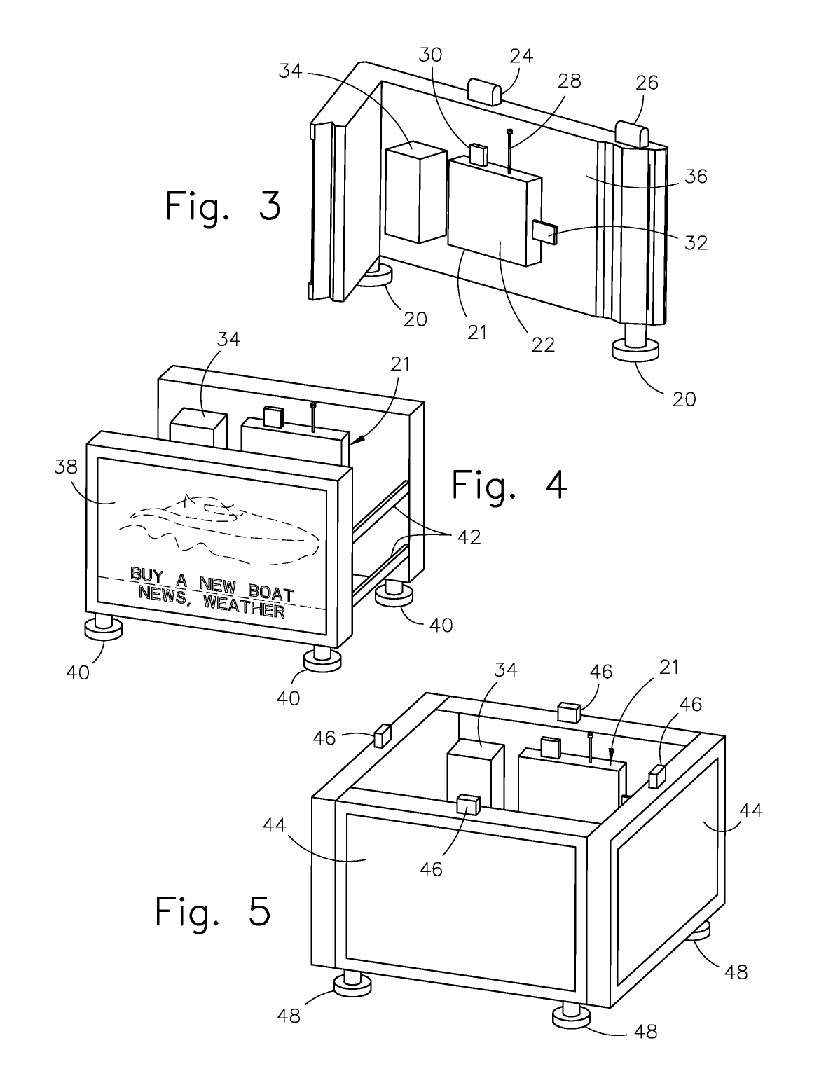

Referring now to FIGS. 2 and 3 where examples of the electronic components are shown in more detail. It should also be appreciated that similar configuration and variations could be used in any of the varieties of the device. Also, these components are merely illustrative and may not have all features present or in the form factor shown.

Generally the device is powered by a power supply 34 that may be battery, multiple batteries or other sources such as a fuel cell or other technologies to provide mobile power as may be utilized in the future. Although not depicted in the drawings the power to operate the device may also come from the vehicle's electrical system. The vehicle's power may be used to recharge the batteries or to directly operate the device without batteries.

The controller assembly 21 receives power from the vehicle or power supply 34 which powers a processor 22 that is contained and protected inside the controller assembly 21. Preferably the controller assembly is watertight to keep the contents safe from inclement weather as it is intended to be kept on top of a vehicle for protracted periods.

The processor's 22 principal function is to manage the power in the power supply 34 and to feed video, whether still images or full motion video, to the several displays 12, 38 and 44. Each of the displays 12, 38 and 44 could optionally be controlled independently or could be synchronized to display the same content. Black and white, full color or monochrome displays 12, 38 and 44 could be used to display either motion video or a series of still frames. Three dimensional displays could also be used effectively.

The processor 22 also manages the acquisition of video content. Antenna 28 is provided that can receive data from a wireless source such as over a cellular network, satellite or other commonly available data feed. This data feed is preferably two-way internet based. In other words, it can send and receive internet data sources. In a preferred variation the internet feed can then be re-transmitted via antenna 32 to act as an internet ‘hot spot’ so that other wireless devices can have internet access. This feature may be useful, for example, to provide a secure internet link to passengers in the vehicle.

The internet connectivity can also supply up to the minute information to be displayed on the displays 12, 38 and 44 such as breaking news, sports scores and weather, to name just a few. The content displayed can be selected from controls inside the vehicle, from any internet enabled device or from a central data assembly service that broadcasts suitable content for display.

Antenna 30 is optionally provided to accurately receive global positioning (GPS) information and provide this data to the processor 22. The processor 22 then has the ability to provide geographically relevant video content. For example, if the GPS detects that it is near the airport then traveler relevant material can be displayed such as local weather, flight information or local interest topics such as advertising local hotels, restaurants and events.

For another example, if the GPS detects that the device is near a sports venue then recent scores could be displayed. In yet another example, advertisers could elect to have their ads displayed only when in certain defined geographical locations, such as when near their closest place of business.

Button 14 is provided to turn the device on and off. Button 14 could also put the device into a hibernation mode to conserve energy yet allow the device to boot up and turn on quickly when needed. Other controls, may be optionally present to, for example, adjust the brightness of the display for optimal viewing in various daylight conditions and also to conserve power in lower light environments.

A motion detector 16 is optionally provided to detect the approach of persons near the vehicle. For example, if a taxi using the device is not occupied but waiting for a fare then as a prospective client comes near the vehicle the displays become active and turn on. The device can also be configured so that the cameras 24, 26 or 46 turn on only when the motion detector 16 detects a person in close proximity.

In an alternate variation, instead of a separate motion detector 16, the cameras 24, 26 or 46 may continually scan for motion near the vehicle to trigger the displays on or off. If the cameras detect motion then they could signal the controller assembly 21 to turn on or off any of the displays individually or simultaneously.

The controller assembly 21 may also have a removable media port to manually add data to the controller assembly 21. The removable media may be any of a variety of commonly available devices such as memory sticks or memory cards.

The controller assembly 21 preferably also includes a memory storage device included to store video content when wireless connectivity is unavailable. The memory storage may also be used to buffer streaming video when the data transmission rate is low. The memory storage device could be any variety of commonly available devices such as a hard drive, solid state memory, static memory or flash memory.

Optionally provided are one or more cameras 46 that capture video and still images around the vehicle. This can be a theft deterrent. Video can also monitor for the safety of the passengers or to supervise drivers. This may be useful for drivers for hire, such as a taxi or limousine and could also be useful for monitoring youthful, inexperienced drivers. The images captured by the cameras 46 may be stored on the internal memory device and also may be transmitted via the internet to remote locations for storage and review.

Referring to FIG. 4, additional frame 42 elements may be necessary to adequately support the displays 38 in alternate configurations. The Frame 42 may also be utilized as a handle to aid a user in installing and removing the device from a vehicle's roof.

The optional GPS capability may also be used for recovery after theft of the device. GPS may also be used to monitor the location of a delivery vehicle, such as food deliveries, to ensure that the driver is in the proper location or to help coordinate the vehicle's return for re-supply and continued delivery.

The controller assembly may have a motion sensing means included. This could be a dedicated device or may by derived from the GPS. The invention can then be programmed to turn on or off depending on whether the vehicle is in motion. For example, if the device detects that it is moving at highway speeds then the displays 12, 38 or 44 may turned off to conserve energy because they are unlikely to be seen at such speed. Alternatively, in some instances it may be found to be distracting to other drivers to have video displaying at a given speed. In yet other instances, for example when stopped, the device could provide video and optionally audio output when passers by may be able to hear and see the device most easily.

An important variation of the invention may be described as a mobile advertising device for display of visual content comprising a frame, a plurality of displays, a controller assembly and power supply. Said frame is generally disposed between the displays and supports the displays as well as other necessary components. The frame typically has a plurality of feet provided to support the device on the roof of a passenger vehicle, such as a taxi. The power supply is optionally affixed to the frame, is rechargeable and provides power to the controller assembly and the displays. The power supply could be integrated to the vehicle's electrical system for recharging or positioned remotely, for example, in the trunk or glove box. In some versions a battery is not needed when connected to the car's battery and electrical system. The controller assembly has a video content generating means and means to deliver said video content to the displays and may have a global positioning system receiver. The controller assembly may be affixed to the frame or may be placed in a safer location such as the trunk or inside the cabin. Preferably the controller assembly includes a wide area network (WAN) wireless internet connection transceiver that connects to the internet to in turn relay internet data to the passengers on a local area network (LAN) wireless hot spot or Wi-Fi, similar to a household internet router. Then riders in the vehicle can use the internet on their mobile device such as a lap top or handheld device. The controller assembly optionally has the capability to detect the speed at which the device is moving to selectively turn the displays on and off at predetermined speeds. For example, turn the displays off if moving at high speeds or to turn on when parked to signal that the cab is ready to receive a passenger. A plurality of cameras may be affixed to said frame and deliver images to said controller assembly or feed over the internet as a web cam.

The mobile advertising device may further include a magnetism means in the feet to secure the device to a metal roof of the vehicle. It could also be permanently affixed to the vehicle roof. It could also include a means to store video content to be shown on said displays on a hard drive or other storage means. Equally, any images captured by the optional cameras could be stored locally or broadcast to a remote system. A means to adjust the brightness of the displays is optionally provided.

A special variation may be further characterized in that a means to detect motion near said passenger vehicle is provided that selectively cause the displays to turn on or off. For example, to conserve energy, the displays turn on only when motion is detected near to or approaching the vehicle.

Another important version of the mobile advertising device for display of visual content comprises a frame, a plurality of displays, a controller assembly and power supply. The frame typically is present to support the displays and other hardware necessary for the device to operate. Feet may be provided to support the device on the roof of a passenger vehicle or other surface. The power supply and controller assembly may be affixed to the frame or could be remotely located inside the vehicle. The power supply may have a rechargeable battery or may be integrated into the car's electrical system, as determined by the application.

The controller assembly has a video content generating means and means to deliver said video content to the displays, typically a wired system but it could be wirelessly connected. Preferably the controller assembly includes a global positioning system receiver and a wide area network (WAN) wireless internet connection transceiver to connect to an internet node. It then can include a local area network wireless hot spot to give web access to passengers. A plurality of cameras may be affixed to said frame and deliver images to said controller assembly.

This version may be further characterized in that the device is permanently affixed to the roof of said passenger vehicle at the plurality of feet or may be fixed to the vehicle with magnets, straps, clasps or other means available.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A mobile advertising device for display of visual content comprising a frame, a plurality of displays, a controller assembly and power supply;
Said frame is disposed between said displays and supports the displays;
Said frame further having a plurality of feet provided to support the device on the roof of a passenger vehicle;
Said power supply is affixed to said frame, is rechargeable and provides power to said controller assembly and said displays;
Said controller assembly has a video content generating means and means to deliver said video content to the displays;
Said controller assembly includes a global positioning system receiver;
Said controller assembly includes a wide area network wireless internet connection transceiver;
Said controller assembly includes a local area network wireless hot spot;
Said controller assembly detects the speed at which the device is moving to selectively turn the displays on and off at predetermined speeds;
A plurality of cameras are affixed to said frame and deliver images to said controller assembly.

2. A mobile advertising device such as disclosed in claim 1, further characterized in that said feet include a magnetism means to secure the device to a metal roof of a vehicle.

3. A mobile advertising device such as disclosed in claim 1, further characterized in that said controller assembly includes a means to store video content to be shown on said displays.

4. A mobile advertising device such as disclosed in claim 1, further characterized in that said controller assembly includes a means to store video content captured by said cameras.

5. A mobile advertising device such as disclosed in claim 1, further characterized in that a means to adjust the brightness of the displays is provided.

6. A mobile advertising device such as disclosed in claim 1, further characterized in that a means to detect motion near said passenger vehicle is provided that selectively cause the displays to turn on or off.

7. A mobile advertising device for display of visual content comprising a frame, a plurality of displays, a controller assembly and power supply;
Said frame is disposed between said displays and supports the displays;
Said frame further having a plurality of feet provided to support the device on the roof of a passenger vehicle;
Said power supply provides power to said controller assembly and said displays;
Said power supply and said controller assembly are remotely located inside said passenger vehicle;
Said controller assembly has a video content generating means and means to deliver said video content to the displays;
Said controller assembly includes a global positioning system receiver;
Said controller assembly includes a wide area network wireless internet connection transceiver;
Said controller assembly includes a local area network wireless hot spot;
A plurality of cameras are affixed to said frame and deliver images to said controller assembly.

8. A mobile advertising device such as disclosed in claim 7, further characterized in that said power supply is the passenger vehicle's electrical system.

9. A mobile advertising device such as disclosed in claim 7, further characterized in that the device is permanently affixed to the roof of said passenger vehicle at said plurality of feet.
